(19) United States
(12) Patent Application Publication
(10) Pub. No.: US 2020/0094561 A1
(43) Pub. Date: Mar. 26, 2020

(54) RECORDING DEVICE

(71) Applicant: SEIKO EPSON CORPORATION, Tokyo (JP)

(72) Inventor: Hiroki AOKI, Matsumoto-shi (JP)

(21) Appl. No.: 16/582,512

(22) Filed: Sep. 25, 2019

(30) Foreign Application Priority Data
Sep. 26, 2018 (JP) 2018-180558

(51) Int. Cl. B41J 2/165

(52) U.S. Cl. CPC B41J 2/16532

(57) ABSTRACT

A recording device includes a supporting stage including a supporting surface formed with a plurality of suction holes and configured to support a target recording medium transported along the supporting surface by applying a negative pressure to an internal space that communicating with the suction holes, a recording head configured to eject a fluid onto the target recording medium supported by the supporting surface to perform recording, and a partition member configured to block a flow of gas in the internal space. The supporting surface includes, in a transport direction of the target recording medium, a first region where a first suction force is generated and a second region where a second suction force weaker than the first suction force is generated.

The present application is based on and claims priority from JP Application Serial Number 2018-180558, filed Sep. 26, 2018, the disclosure of which is hereby incorporated by reference herein in its entirety.

### BACKGROUND

### 1. Technical Field

The present disclosure relates to a recording device.

### 2. Related Art

Recording devices of various configurations have been used. Of these, a recording device is configured to support a target recording medium to be transported by a supporting surface in which a suction hole is formed while sucking the target recording medium, and to perform recording on the target recording medium transported while being supported by the supporting surface.

For example, JP-A-2017-121705 discloses a printer configured to support a piece of recording paper by a suction platen in which a plurality of suction holes are formed while sucking the piece of recording paper, and to perform recording on the piece of recording paper transported while being supported by the suction platen.

As in the printer of JP-A-2017-121705, in a configuration including a supporting stage that supports a target recording medium by a supporting surface in which a suction hole is formed while sucking the target recording medium, when suction force on the supporting surface of the target recording medium is weak, floating of the target recording medium may be generated, and a recording failure may thus occur. On the other hand, when the suction force on the supporting surface of the target recording medium is strong, resistance between the target recording medium and the supporting surface increases. Accordingly, the target recording medium may not be transported, which may cause an occurrence of transport failure, and an increase of load on a motor in a transport unit of the target recording medium.

### SUMMARY

A recording device according to the present disclosure in order to solve the above-described problem includes a supporting stage including a supporting surface formed with a plurality of suction holes and configured to support a target recording medium transported along the supporting surface by applying a negative pressure to an internal space communicating with the suction holes, a recording head configured to eject a fluid onto the target recording medium supported by the supporting surface to perform recording, and a partition member configured to block a flow of gas inside the internal space. The supporting surface includes, in a transport direction of the target recording medium, a first region where a first suction force is generated and a second region where a second suction force weaker than the first suction force is generated.

### BRIEF DESCRIPTION OF THE DRAWINGS

FIG. 1 is a side view illustrating a recording device according to Example 1 of the present disclosure.

FIG. 2 is a perspective view illustrating the recording device according to Example 1 of the present disclosure when viewed from a back side.

FIG. 3 is a perspective view illustrating the recording device according to Example 1 of the present disclosure when viewed from a front side.

FIG. 4 is a block diagram of the recording device according to Example 1 of the present disclosure.

FIG. 5 is a perspective view illustrating a part of the recording device according to Example 1 of the present disclosure, and illustrates a state in which a supporting surface is removed.

FIG. 6 is a perspective view illustrating a support mechanism of the recording device according to Example 1 of the present disclosure, and illustrates a state in which the supporting surface is removed.

FIG. 7 is a perspective view illustrating the support mechanism of the recording device according to Example 1 of the present disclosure, and illustrates a state in which a partition member is removed from the state illustrated in FIG. 6.

FIG. 8 is a side cross-sectional view illustrating the support mechanism of the recording device according to Example 1 of the present disclosure.

FIG. 9 is a side cross-sectional view schematically illustrating the support mechanism of the recording device according to Example 1 of the present disclosure.

FIG. 10 is a side cross-sectional view schematically illustrating a support mechanism of a recording device according to Example 2 of the present disclosure.

FIG. 11 is a side cross-sectional view schematically illustrating a support mechanism of a recording device according to Example 3 of the present disclosure.

### DESCRIPTION OF EXEMPLARY EMBODIMENTS

First, the present disclosure will be described schematically.

In order to solve the above-described problem,a recording device according to a first aspect of the present disclosure includes a supporting stage including a supporting surface formed with a plurality of suction holes and configured to support a target recording medium transported along the supporting surface by applying a negative pressure to an internal space communicating with the suction holes, a recording head configured to eject a fluid onto the target recording medium supported by the supporting surface to perform recording, and a partition member configured to block a flow of gas inside the internal space. The supporting surface includes, in a transport direction of the target recording medium, a first region where a first suction force is generated and a second region where a second suction force weaker than the first suction force is generated.

According to the aspect, the recording device includes the partition member which blocks the flow of gas in the internal space of the supporting stage, and includes, in the supporting surface, the first region in which a strong first suction force is generated and the second region in which a weak second suction force is generated. Thus, for example, by setting, as the first region, a region that may lead to a recording failure when floating of the target recording medium occurs, and setting a remaining region as the second region, resistance between the target recording medium and the supporting surface can be reduced while suppressing a recording failure.

In a recording device according to a second aspect of the present disclosure, in the first aspect, the partition member in the internal space is configured to be detachable.

According to the aspect, the partition member is configured to be detachable in the internal space, and thus the partition member can be easily replaced, cleaned, and the like.

In a recording device according to a third aspect of the present disclosure, in the first or second aspect, the partition member in the internal space is configured to be movable in the transport direction.

According to the aspect, the partition member is configured to be movable in the transport direction in the internal space, and thus a ratio of the first region to the second region in the transport direction can be easily changed depending on a type of the target recording medium to be used, and the like.

In a recording device according to a fourth aspect of the present disclosure, in any one of the first to third aspects, the partition member in the internal space is configured to be movable in a direction intersecting the transport direction.

According to the aspect, the partition member is configured to be movable in the direction intersecting the transport direction in the internal space, and thus a ratio of the first region to the second region in the direction intersecting the transport direction can be easily changed depending on a width of the target recording medium to be used, and the like.

A recording device according to a fifth aspect of the present disclosure includes a supporting stage including a supporting surface formed with a plurality of suction holes and configured to support a target recording medium transported along the supporting surface by applying a negative pressure to an internal space communicating with the suction holes, and a recording head configured to eject a fluid onto the target recording medium supported by the supporting surface to perform recording. The supporting surface includes, in a transport direction of the target recording medium, a first region where a first suction force is generated and a second region where a second suction force is generated. The suction hole formed in the second region is configured to have a shape different from that of the suction hole formed in the first region, thereby causing the second suction force to be weaker than the first suction force.

According to the aspect, the suction hole formed in the second region is configured to have a shape different from that of the suction hole formed in the first region, and thus the second suction force is caused to be different from the first suction force. In other words, the supporting surface includes the first region in which a strong first suction force is generated, and the second region in which a weak second suction force is generated. Thus, for example, by setting, as the first region, a region that may lead to a recording failure when floating of the target recording medium occurs, and setting a remaining region as the second region, resistance between the target recording medium and the supporting surface can be reduced while suppressing a recording failure.

In a recording device according to a sixth aspect of the present disclosure, in the fifth aspect, the suction hole formed in the first region is a through hole extending in a direction intersecting the transport direction.

According to the aspect, the suction hole formed in the first region is a through hole extending in the direction intersecting the transport direction, and thus a suction hole having a larger opening area and a stronger suction force than those of the suction hole formed in the second region can be easily formed.

In a recording device according to a seventh aspect of the present disclosure, in any one of the first to sixth aspects, the second region is positioned such that the first region is interposed between the second region and another second region in the transport direction.

According to the aspect, the second region is positioned such that the first region is interposed between the second region and another second region in the transport direction. In other words, the second region in which a weak second suction force is generated sandwiches the first region in which a strong first suction force is generated in the transport direction. Thus, the target recording medium to be transported can be prevented from being caught in a suction region formed of the first region and the second region when the target recording medium passes through the suction region, and a transport failure of the target recording medium can be suppressed.

In a recording device according to an eighth aspect of the present disclosure, in any one of the first to seventh aspects, the internal space communicating with the suction hole formed in the first region and the internal space communicating with the suction hole formed in the second region are provided in one negative pressure chamber.

According to the aspect, the internal space that communicates with the suction hole formed in the first region and the internal space that communicates with the suction hole formed in the second region are provided in one negative pressure chamber. Thus, the configuration of the supporting stage can be simplified.

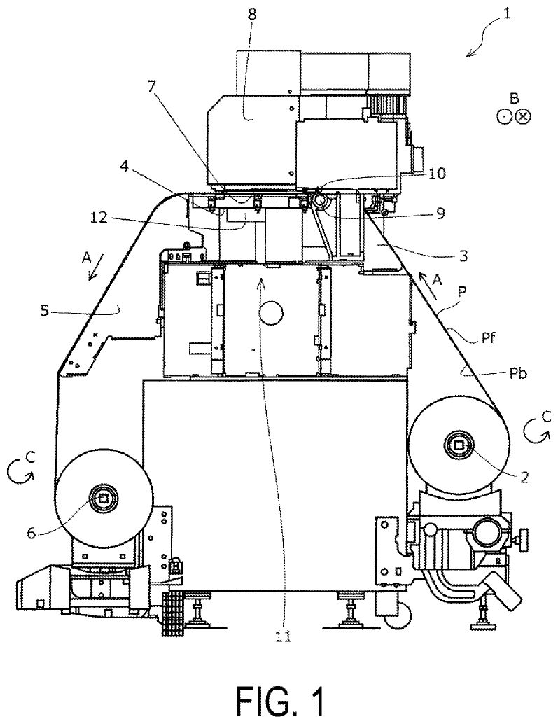

Next, a recording device according to an example of the present disclosure will be described in detail with reference to the appended drawings. First, an outline of a recording device 1 according to the example will be described with reference to FIGS. 1 to 3. Note that the recording device 1 according to the example is an inkjet recording device configured to discharge ink that is a liquid (fluid) from a recording head 7 onto a target recording medium P, and perform recording.

As illustrated in FIG. 1, the recording device 1 according to the example transports the target recording medium P in a transport direction A from a set unit 2 of the target recording medium P to a winding unit 6 of the target recording medium P via a platen 3, a platen 4, and a platen 5 that are supporting stages of the target recording medium P. In other words, a path from the set unit 2 to the winding unit 6 is a transport path of the target recording medium P in the recording device 1, and the platen 3, the platen 4, and the platen 5 are supporting stages of the target recording medium P provided in the transport path. Here, the set unit 2 rotates in a rotation direction C to feed the target recording medium P, and the winding unit 6 rotates in the rotation direction C to wind the target recording medium P. Note that the recording device 1 according to the example includes, as a main component, a support mechanism 11 including the platen 4 and the like that include a position facing the recording head 7 and support the target recording medium P. The support mechanism 11, which is a main component of the recording device 1 according to the example, will be described below in detail.

Here, the recording device 1 according to the example is configured to be able to perform recording on the target recording medium P having a roll shape, but the recording device 1 is not limited to this configuration, and may be configured to be able to perform recording on the target recording medium P having a single sheet shape. When the recording device 1 is configured to be able to perform recording on the target recording medium P having a single sheet shape, for example, a so-called feeding tray, feeding cassette, or the like may be used as the set unit 2 of the target recording medium P. Further, for example, a so-called discharge receiving portion, discharge tray, discharge cassette, or the like may be used as a collection unit of the target recording medium P and as a collection unit other than the winding unit 6.

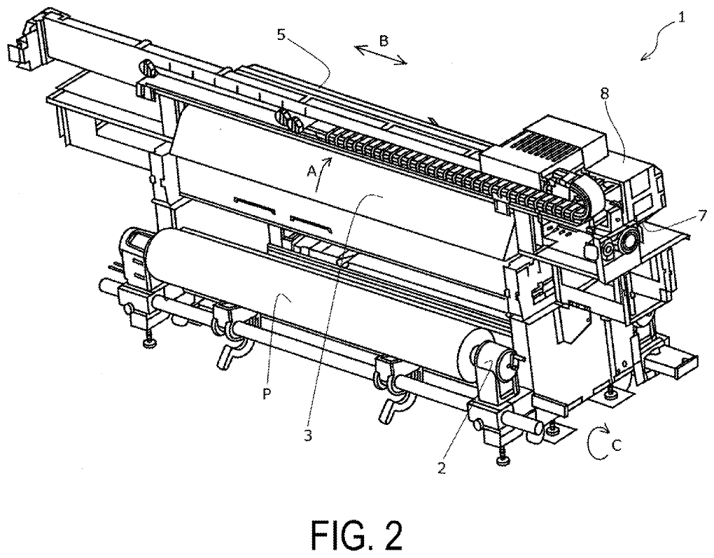

Note that the target recording medium P of a roll type wound with a recording surface Pf facing outward is used in the example, and thus when the target recording medium P is fed from the set unit 2, a rotary shaft of the set unit 2 rotates in the rotation direction C. On the other hand, when the target recording medium P of a roll type wound with the recording surface Pf facing inward is used, the rotary shaft of the set unit 2 can rotate in a direction opposite to the rotation direction C to feed the target recording medium P. Note that FIG. 2 illustrates a state in which the target recording medium P is set in the set unit 2, and a state before the target recording medium P is introduced into the transport path of the target recording medium P.

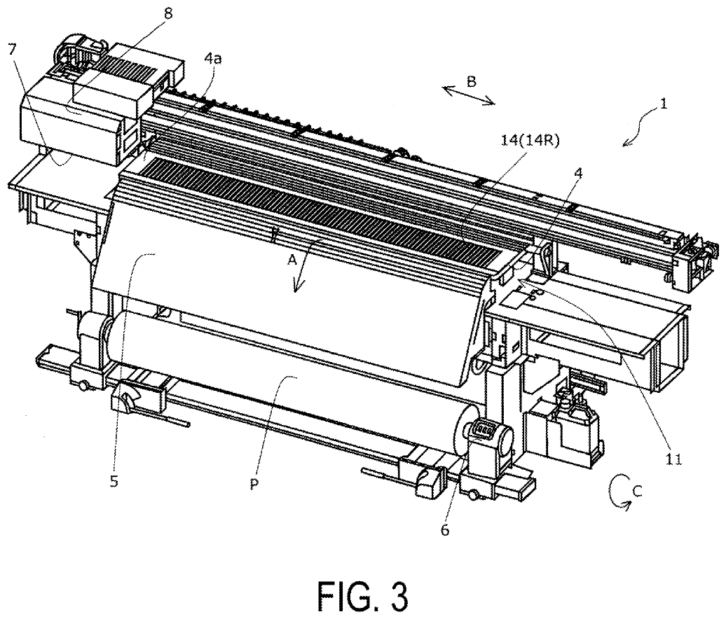

Then, similarly, the winding unit 6 according to the example winds the target recording medium P such that the recording surface Pf of the target recording medium P faces outward, and thus the rotary shaft of the winding unit 6 rotates in the rotation direction C. On the other hand, when winding takes place to allow the recording surface Pf to face inward, the rotating shaft of the winding unit 6 can rotate in the direction opposite to the rotation direction C to wind the target recording medium P. Note that FIG. 3 illustrates a state in which all of the target recording medium P is wound by the winding unit 6 from the transport path of the target recording medium P.

Note that a heater may be provided in at least one of the platen 3, the platen 4, and the platen 5. By providing the heater in the platen 3, the target recording medium P can be heated before recording is performed by the recording head 7. Further, by providing the heater in the platen 4, the target recording medium P can be heated in a position where recording is performed by the recording head 7. Further, by providing the heater in the platen 5, the target recording medium P recorded by the recording head 7 can be heated before being wound by the winding unit 6. Note that the heater may be an electrically heated wire or the like that heats the target recording medium P from a back surface Pb side of the target recording medium P on the opposite side of the recording surface Pf, but may be an infrared heater that heats the target recording medium P by irradiation with electromagnetic waves from the recording surface Pf side of the target recording medium P.

Further, as illustrated in FIG. 1, the recording device 1 according to the example includes a driving roller 9 that includes a rotary shaft in an intersecting direction B intersecting the transport direction A between the platen 3 and the platen 4, and that applies a feeding force to the back surface Pb of the target recording medium P. Then, as illustrated in FIG. 1, the recording device 1 according to the example is provided with a driven roller 10 in a position facing the driving roller 9. Note that the driven roller refers to a roller that rotates with the rotation of the driving roller 9 as the driving roller 9 is driven to transport the target recording medium P.

Further, as illustrated in FIGS. 1 to 3, the recording device 1 according to the example includes a carriage 8 including the recording head 7 at a side facing the platen 3 downstream of the driving roller 9 in the transport direction A. The recording device 1 discharges ink onto the target recording medium P from a nozzle (not illustrated) formed in the recording head 7 while moving the recording head 7 back and forth in the intersecting direction B via the carriage 8, and forms a desired image.

Note that the recording device 1 according to the example includes the recording head 7 configured to perform recording while moving back and forth. However, the recording device may instead include a so-called line head including a plurality of nozzles configured to discharge ink provided in the intersecting direction B intersecting the transport direction A.

Here, a “line head” is a recording head provided such that a region including the nozzles formed in the intersecting direction B intersecting the transport direction A of the target recording medium P is provided to be capable to cover the entirety of that intersecting direction B of the target recording medium P, and is used in a recording device that forms an image by moving at least one of the recording head and the target recording medium P relative to each other. Note that in the line head, the region including the nozzles in the intersecting direction B may not be provided to be capable to cover the entirety of the intersecting direction B for all types of the target recording medium P that can be used in the recording device.

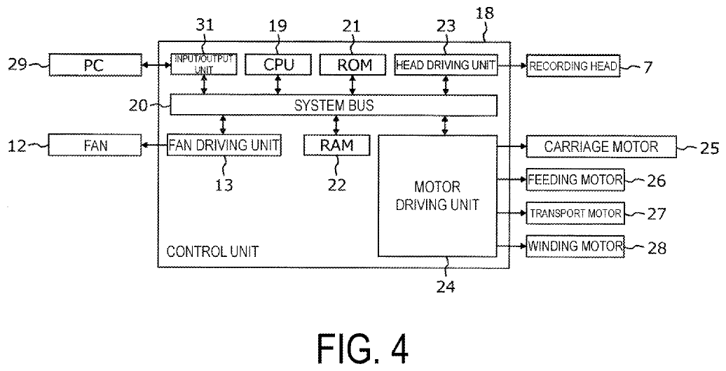

Next, an electrical configuration of the recording device 1 according to the example will be described with reference to FIG. 4.

A control unit 18 includes a CPU 19 that manages control of the entire recording device 1. The CPU 19 is coupled, through a system bus 20, to a ROM 21 that stores, for example, various types of control programs and a maintenance sequence to be executed by the CPU 19, and a RAM 22 that can temporarily store data.

Further, the CPU 19 is coupled, through the system bus 20, to a head driving unit 23 configured to drive the recording head 7.

Further, the CPU 19 is coupled, through the system bus 20, to a motor driving unit 24 configured to drive a carriage motor 25 that is configured to move the carriage 8 along the intersecting direction B, a feeding motor 26 that is a drive source of the set unit 2, a transport motor 27 that is a drive source of the driving roller 9, and a winding motor 28 that is a drive source of the winding unit 6.

Further, the CPU 19 is coupled, through the system bus 20, to a fan driving unit 13 configured to drive a fan 12 provided in the support mechanism 11, which will be described below in detail.

Furthermore, the CPU 19 is coupled, through the system bus 20, to an input/output unit 31, and the input/output unit 31 is coupled to a PC 29 that is an external device configured to input recorded data and the like into the recording device 1.

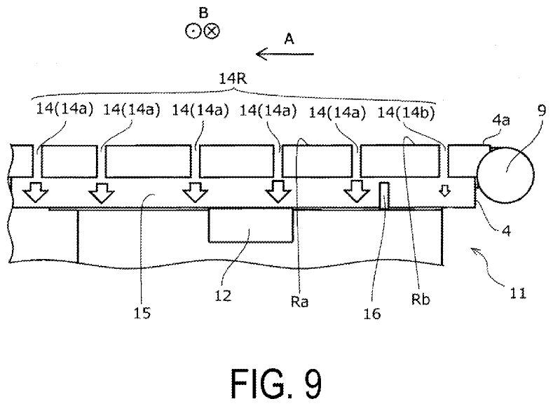

The support mechanism 11 that is a main component of the recording device 1 according to the example will be described next with reference to FIG. 3 and FIGS. 5 to 9. Note that the size of an arrow in FIG. 9 corresponds to the strength of suction force.

As illustrated in FIGS. 3 and 9, a suction hole row 14R in which a plurality of suction holes 14 are formed side by side along the transport direction A is formed in a supporting surface 4a of the platen 4 of the recording device 1 according to the example. Here, as illustrated in FIG. 3, the suction hole row 14R includes a plurality of rows formed along the intersecting direction B substantially across the entirety of the intersecting direction B of the supporting surface 4a. Note that all of the suction holes 14 in the recording device 1 according to the example are round holes, but the shape of the suction hole 14 is not particularly limited.

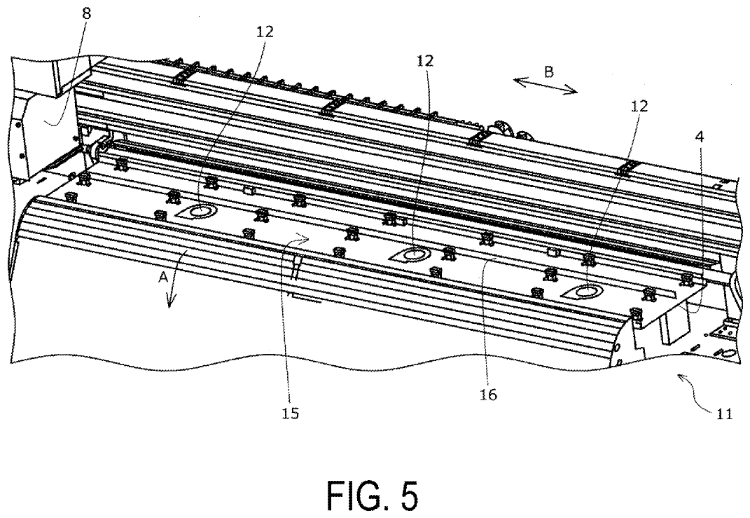

As illustrated in FIGS. 5 to 9, an internal space 15 that communicates with the suction hole 14 is provided below the supporting surface 4a of the platen 4. The fan 12, which is capable of forming a negative pressure in the internal space 15 by discharging air in the internal space 15 to the outside of the recording device 1, is provided below the internal space 15. Note that, in the recording device 1 according to the example, three fans 12 are provided side by side in the intersecting direction B, but arrangement and the number of the fans 12 are not particularly limited.

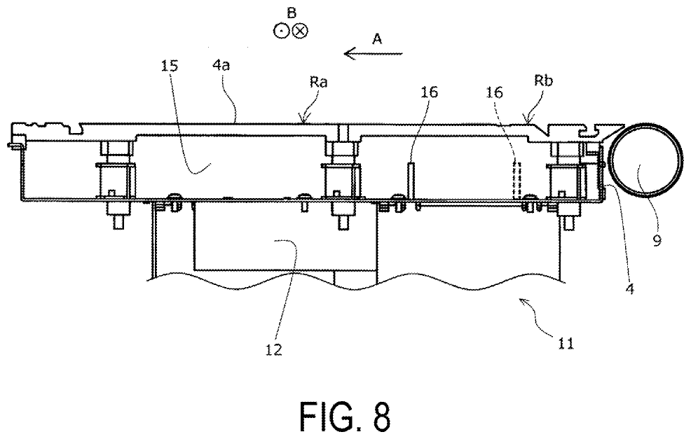

Further, as illustrated in FIG. 5 and the like, a partition member 16 that extends in the intersecting direction B is provided in the internal space 15. The partition member 16 serves to block a flow of gas inside the internal space 15. Note that, as illustrated in FIG. 8, the partition member 16 has a height that does not contact the supporting surface 4a. By providing the partition member 16 having such a height, the negative pressure at the side in which the fan 12 is located with reference to the partition member 16 in the internal space 15 is increased, and the negative pressure at the side in which the fan 12 is not located with reference to the partition member 16 in the internal space 15 is reduced. In other words, as indicated by the size of the arrow in FIG. 9, suction force of a suction hole 14a being the suction hole 14 at the side in which the fan 12 is located is strengthened, and suction force of a suction hole 14b being the suction hole 14 at the side in which the fan 12 is not located is weakened. In other words, as illustrated in FIGS. 8 and 9, the supporting surface 4a includes a first region Ra being a region corresponding to the side at which the fan 12 is located and in which a first suction force is generated, and a second region Rb being a region corresponding to the side at which the fan 12 is not located and in which a second suction force weaker than the first suction force is generated.

Here, in the recording device 1 according to the example, the side of the supporting surface 4a at which the fan 12 is located corresponds to a region facing a portion of the recording head 7 in which the nozzle is formed, and the side of the supporting surface 4a at which the fan 12 is not located corresponds to the other region. With such a configuration, the target recording medium P is securely adsorbed by the supporting surface 4a in a region where an image is formed by the recording head 7, and a gap between the recording head 7 and the target recording medium P is managed with high accuracy. Also, the adsorption force is weakened in a region where the image is not formed, and a transport load of the target recording medium P is reduced.

To give a brief summary here, the recording device 1 according to the example includes the supporting surface 4a in which the plurality of suction holes 14 are formed, the platen 4 configured to support the target recording medium P transported along the supporting surface 4a by applying a negative pressure to the internal space 15 that communicates with the suction hole 14, the recording head 7 configured to eject ink being a fluid onto the target recording medium P supported by the platen 4, and perform recording, and the partition member 16 configured to block the flow of gas inside the internal space 15. Then, the supporting surface 4a includes, in the transport direction A, the first region Ra in which the first suction force is generated, and the second region Rb in which the second suction force weaker than the first suction force is generated.

As described above, the recording device 1 according to the example includes the partition member 16, which blocks the flow of gas, in the internal space 15 of the platen 4, and includes, in the supporting surface 4a, the first region Ra in which a strong first suction force is generated, and the second region Rb in which a weak second suction force is generated. In other words, in the recording device 1 according to the example, in the supporting surface 4a, the region facing the portion in which the nozzle of the recording head 7 is formed, which may lead to a recording failure when floating of the target recording medium P occurs, is set as the first region Ra, and a remaining region is set as the second region Rb. Thus, resistance between the target recording medium P and the supporting surface 4a is reduced while suppressing a recording failure.

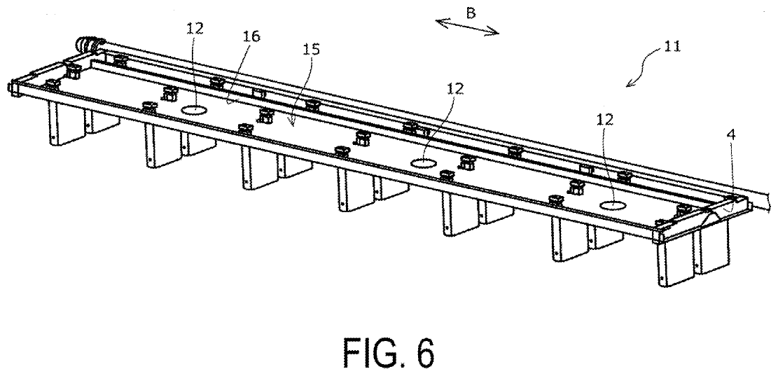

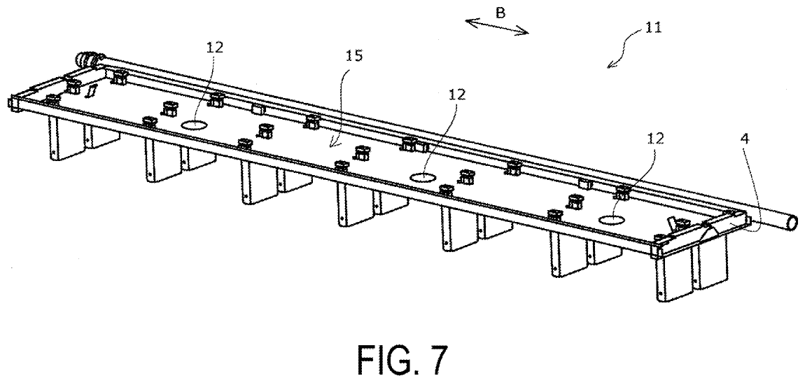

Here, in the recording device 1 according to the example, the partition member 16 is configured to be detachable in the internal space 15. Here, FIG. 6 illustrates a state in which the partition member 16 is attached to the internal space 15, and FIG. 7 illustrates a state in which the partition member 16 is removed from the internal space 15. Since the partition member 16 is configured to be detachable in the internal space 15, the recording device 1 according to the example has a configuration in which the partition member 16 can be easily replaced, cleaned, and the like.

Further, in the recording device 1 according to the example, the partition member 16 is configured to be movable along the transport direction A in the internal space 15. Here, the solid lines in FIGS. 5 and 8 represent a state in which the partition member 16 is moved to the most downstream side in the transport direction A, and the dashed lines in FIGS. 6 and 8 represent a state in which the partition member 16 is moved to the most upstream side in the transport direction A. Since the partition member 16 is configured to be movable in the transport direction A in the internal space 15, the recording device 1 according to the example can easily change a ratio of the first region Ra to the second region Rb in the transport direction A depending on a type of the target recording medium P to be used, a position of the nozzle of the recording head 7 to be used, and the like. Note that, in the recording device 1 according to the example, the partition member 16 is configured to be manually moved by a user, but the partition member 16 may be configured to be automatically moved by control of the control unit 18 using, for example, driving force of a motor.

Note that the partition member 16 may have a configuration in which the shape of the partition member 16 is changed and the partition member 16 is movable in the intersecting direction B intersecting the transport direction in the internal space 15. This is because, by configuring the partition member 16 to be movable in the intersecting direction B in the internal space 15, a ratio of the first region Ra to the second region Rb in the intersecting direction B can be easily changed depending on a width of the target recording medium P to be used and the like.

Further, in the recording device 1 according to the example, the internal space 15 forming a negative pressure chamber is one. In another expression, the internal space 15 that communicates with the suction hole 14a formed in the first region Ra, and the internal space 15 that communicates with the suction hole 14b formed in the second region Rb are provided in one negative pressure chamber. Thus, the configuration of the platen 4 is simplified in the recording device 1 according to the example.

Example 2

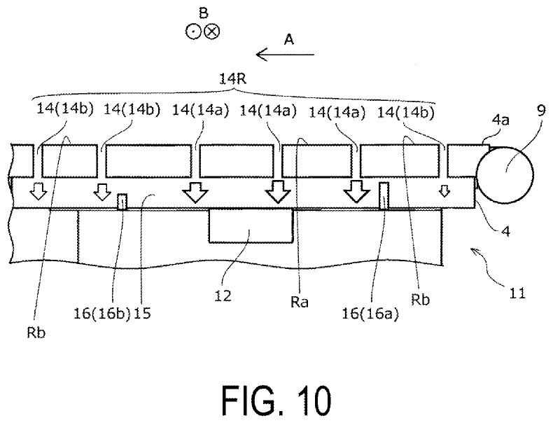

FIG. 10

Next, a recording device 1 according to Example 2 will be described with reference to FIG. 10.

FIG. 10 is a side cross-sectional view schematically illustrating a support mechanism 11 of the recording device 1 according to the example, and is a diagram corresponding to FIG. 9 that is the diagram of the support mechanism 11 of the recording device 1 according to Example 1. Like numbers designate identical or corresponding component elements in Example 1, described above, and detailed description for such component elements are omitted. Here, the recording device 1 according to the example has a configuration similar to that of the recording device 1 according to Example 1 except that the recording device 1 according to the example includes two partition members 16.

As illustrated in FIG. 10, the support mechanism 11 of the recording device 1 according to the example includes, as the partition members 16, a partition member 16b downstream of a fan 12 in a transport direction A in addition to a partition member 16a having a configuration similar to that of the partition member 16 provided in the support mechanism 11 of the recording device 1 according to Example 1. In another expression, in the recording device 1 according to the example, second regions Rb are provided in positions to sandwich a first region Ra in the transport direction A. In other words, in the transport direction A, the second regions Rb in which a weak second suction force is generated sandwich the first region Ra in which a strong first suction force is generated. Thus, a target recording medium P to be transported can be prevented from being caught in a suction region formed of the first region Ra and the second region Rb when the target recording medium P passes through the suction region, and a transport failure of the target recording medium P is suppressed.

Note that, in the recording device 1 according to the example, as illustrated in FIG. 10, the partition member 16b is configured to have a height smaller than a height of the partition member 16a. Thus, suction force in the second region Rb downstream of the fan 12 in the transport direction A is stronger than suction force in the second region Rb upstream of the fan 12 in the transport direction A. This is because the suction force in the second region Rb downstream in the transport direction A that faces a region in which a nozzle of a recording head 7 is formed is prevented from decreasing excessively. Nevertheless, the recording device 1 is not limited to such a configuration.

Example 3

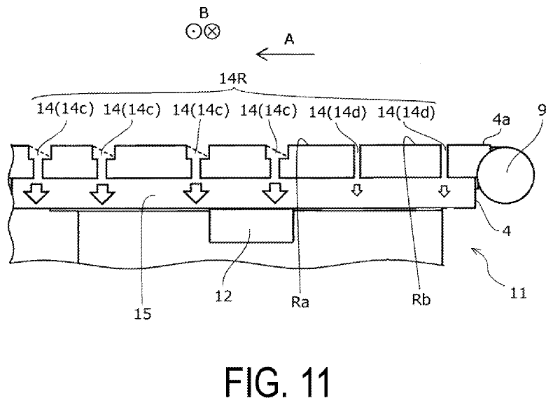

FIG. 11

Next, a recording device 1 according to Example 3 will be described with reference to FIG. 11.

FIG. 11 is a side cross-sectional view schematically illustrating a support mechanism 11 of the recording device 1 according to the example, and is a diagram corresponding to FIG. 9 that is the diagram of the support mechanism 11 of the recording device 1 according to Example 1. Like numbers designate identical or corresponding component elements in Example 1 and Example 2, described above, and detailed description for such component elements are omitted. Here, the recording device 1 according to the example has a configuration similar to that of the recording device 1 according to Example 1 and Example 2 except for the configuration of the support mechanism 11.

The support mechanism 11 of the recording device 1 according to the example includes, as suction holes 14, a slit-shaped suction hole 14c extending in an intersecting direction B, and a suction hole 14d that is a round hole similar to the suction holes 14a and 14b of the recording device 1 according to

Example 1, instead of including a partition member 16 in an internal space 15. An opening area of the slit-shaped suction hole 14c is wider than an opening area of the suction hole 14d being a round hole, and thus suction force of the suction hole 14c is stronger than suction force of the suction hole 14d. This is because, in a case where suction is performed at the same negative pressure, an area for suction is increased with a wider opening area, and thus the suction force becomes stronger. Thus, the suction force is stronger in the first region Ra provided with the suction hole 14c than in the second region Rb provided with the suction hole 14d.

To give a brief summary here, the recording device 1 according to the example includes a supporting surface 4a in which the plurality of suction holes 14 are formed, a platen 4 configured to support a target recording medium P transported along the supporting surface 4a by applying a negative pressure to the internal space 15 that communicates with the suction hole 14, and a recording head 7 configured to eject ink onto the target recording medium P supported by the supporting surface 4a and perform recording. Then, the supporting surface 4a includes, in the transport direction A, the first region Ra in which a first suction force is generated, and the second region Rb in which a second suction force is generated. Then, the suction hole 14d formed in the second region Rb is configured to have a shape different from that of the suction hole 14c formed in the first region Ra, causing the second suction force to be weaker than the first suction force.

Similar to the recording device 1 according to Example 1 and Example 2, the recording device 1 according to the example also includes, in the supporting surface 4a, the first region Ra in which a strong first suction force is generated and the second region Rb in which a weak second suction force is generated. Thus, also in the recording device 1 according to the example similar to the recording device 1 according to Example 1 and Example 2, in the supporting surface 4a, the region in which a nozzle of the recording head 7 is formed, which may lead to a recording failure when floating of the target recording medium P occurs, is set as the first region Ra, and a remaining region is set as the second region Rb. Thus, resistance between the target recording medium P and the supporting surface 4a is reduced while suppressing a recording failure.

Note that the slit-shaped suction hole 14c formed in the first region Ra includes a region that is not covered by the target recording medium P when the target recording medium P is supported by the supporting surface 4a at an end portion of the suction hole 14c in the intersecting direction B. In this way, the suction force in the portion that sucks the end portion of the target recording medium P in the intersecting direction B may be weaker than the second suction force due to the air leaking from the end portion of the suction hole 14c. However, the suction hole 14c has a narrow slit width, and thus the suction force is stronger across the entire first region Ra than that in the entire second region Rb.

Note that the suction hole 14c formed in the first region Ra has a slit shape extending in the intersecting direction B, that is, a through hole extending in the intersecting direction B. Thus, in the recording device 1 according to the example, the suction hole 14c having a larger opening area and a stronger suction force than those of the suction hole 14d formed in the second region Rb is easily formed in the first region Ra.

The present disclosure is not limited to the examples described above, and can be realized in various configurations without departing from the gist of the disclosure. Appropriate replacements or combinations may be made to the technical features in the examples which correspond to the technical features in the aspects described in SUMMARY to solve some or all of the problems described above or to achieve some or all of the advantageous effects described above. Additionally, when the technical features are not described herein as essential technical features, such technical features may be deleted appropriately.

What is claimed is:

1. A recording device, comprising:
a supporting stage including a supporting surface formed with a plurality of suction holes and configured to support a target recording medium transported along the supporting surface by applying a negative pressure to an internal space communicating with the suction holes;
a recording head configured to eject a fluid onto the target recording medium supported by the supporting surface to perform recording; and
a partition member configured to block a flow of gas in the internal space, wherein
the supporting surface includes, in a transport direction of the target recording medium, a first region where a first suction force is generated and a second region where a second suction force weaker than the first suction force is generated.

2. The recording device according to claim 1, wherein the partition member in the internal space is configured to be detachable.

3. The recording device according to claim 1, wherein the partition member in the internal space is configured to be movable in the transport direction.

4. The recording device according to claim 1, wherein the partition member in the internal space is configured to be movable in a direction intersecting the transport direction.

5. A recording device, comprising:
a supporting stage including a supporting surface formed with a plurality of suction holes and configured to support a target recording medium transported along the supporting surface by applying a negative pressure to an internal space communicating with the suction holes; and
a recording head configured to eject a fluid onto the target recording medium supported by the supporting surface to perform recording, wherein
the supporting surface includes, in a transport direction of the target recording medium, a first region where a first suction force is generated and a second region where a second suction force is generated, and
the suction hole formed in the second region is configured to have a shape different from that of the suction hole formed in the first region, thereby causing the second suction force to be weaker than the first suction force.

6. The recording device according to claim 5, wherein the suction hole formed in the first region is a through hole extending in a direction intersecting the transport direction.

7. The recording device according to claim 1, wherein the second region is positioned such that the first region is interposed between the second region and another second region in the transport direction.

8. The recording device according to claim 1, wherein
the internal space communicating with the suction hole formed in the first region and the internal space communicating with the suction hole formed in the second region are provided in one negative pressure chamber.
